(19) United States
(12) Patent Application Publication
(10) Pub. No.: US 2007/0296557 A1
(43) Pub. Date: Dec. 27, 2007

(54) METHODS OF PERFORMING A NUMERICAL ANALYSIS ON A POWER DISTRIBUTION NETWORK

(76) Inventors: Jaemin Kim, Seoul (KR); Joungho Kim, Daejeon (KR)

Correspondence Address: DALY, CROWLEY, MOFFORD & DURKEE, LLP, SUITE 301A, 354A TURNPIKE STREET, CANTON, MA, 02021-2714, US

(21) Appl. No.: 11/685,973

(22) Filed: Mar. 14, 2007

(30) Foreign Application Priority Data
Jun. 27, 2006 (KR) 2006-58169

(51) Int. Cl. G05B 11/01

(52) U.S. Cl. 340/310.11

(57) ABSTRACT

A method of performing a numerical analysis on a power distribution network includes obtaining N planes respectively modeling N planes and (N−1) inter-planes respectively modeling electrical interoperation between the neighboring planes, the N planes being vertically coupled, respectively performing numerical analyses on the N planes and the (N−1) inter-planes, and integrating the numerical analysis results based on electrical boundary conditions between the K-th plane of the N planes and the one or two inter-planes neighboring with the K-th plane. Therefore, the power distribution network may be quickly analyzed with high accuracy.

### CROSS-REFERENCE TO RELATED APPLICATIONS

This application claims priority under 35 USC § 119 to Korean Patent Application No. 2006-58169, filed on Jun. 27, 2006 in the Korean Intellectual Property Office (KIPO), the disclosure of which is incorporated herein in its entirety by reference.

### BACKGROUND OF THE INVENTION

1. Field of the Invention

The present invention relates to a numerical analysis method, and more particularly to a method of performing a numerical analysis on a power distribution network, capable of being performed quickly with high accuracy.

2. Description of the Related Art

Nowadays, semiconductor devices operate at high frequencies and consume large amounts of power in order to provide high performance and various kinds of functions. However, as semiconductor manufacturing technology is being developed, power voltages in the semiconductor devices are decreasing. A power distribution network in an overall system has to be accurately analyzed so that the power voltages in the semiconductor devices may be stably provided.

When a large amount of current in some area of the system is intermittently delivered for very short periods of time, noise such as simultaneous switching noise (SSN) may occur. The SSN affects the provision of a stable power supply in the system, and thus various methods for analyzing and predicting the SSN have been proposed so as to improve the SSN.

A system area in which a probability of the SSN occurring is high may be predicted by analyzing impedance characteristics in a frequency domain, and the system may be re-designed so that the SSN in the above system area becomes low. Therefore, accurately analyzing impedance characteristics in a frequency domain is very important.

In order to accurately analyze the impedance characteristics, every element in the system should be accurately modeled. For example, the system may include a board, a package and a semiconductor chip. The semiconductor chip consumes power and performs various kinds of functions. The package is designed to mount the semiconductor on the board, and the board provides a power voltage and a ground voltage to the semiconductor chip. By using a hierarchical architecture of the system, a power distribution network in the system can be accurately analyzed.

There are a lot of commercial programs, such as HFSS™ made by Ansoft, MWS® made by CTS and Cadence® made by Allegro, but such commercial programs may be applied only to localized analyses of the board or the package.

The semiconductor chip has a dimension of about hundreds of nm and the board has a dimension of about tens of mm. Therefore, it is nearly impossible to analyze both the semiconductor chip and the board due to the very large amounts of computation time that are required. That is, it is nearly impossible to analyze the entire system having the semiconductor chip, the board and the package at once by using the conventional programs.

### SUMMARY OF THE INVENTION

Accordingly, the present invention is provided to substantially obviate one or more problems due to limitations and disadvantages of the related art.

Some embodiments of the present invention provide methods of performing a numerical analysis on a power distribution network, capable of being performed quickly with high accuracy.

In some embodiments of the present invention, a method of performing a numerical analysis on a power distribution network having first and second planes, the first and second planes being vertically coupled, includes obtaining a model of the first plane, a model of the second plane, and a model of an inter-plane, the model of the inter-plane defining electrical interoperation between the first and second planes, respectively performing numerical analyses on the models of the first plane, the second plane and the inter-plane; and integrating the numerical analysis results based on an electrical boundary condition between the first plane and the inter-plane, and an electrical boundary condition between the second plane and the inter-plane.

For example, each of the first and second planes may correspond to a semiconductor chip and a package. For another example, the first and second planes may correspond to a package and a board.

In other embodiments of the present invention, a method of performing a numerical analysis on a power distribution network having first, second and third planes, the first, second and third planes being vertically coupled, includes obtaining a model of the first plane, a model of the second plane, a model of the third plane, a model of a first inter-plane, and a model of a second inter-plane, the model of the first inter-plane defining electrical interoperation between the first and second planes and the model of the second inter-plane defining electrical interoperation between the second and third planes, respectively performing numerical analyses on the models of the first, second and third planes, and the models of the first and second inter-planes, and integrating the numerical analysis results based on electrical boundary conditions between the first plane and the first inter-plane, between the second plane and the first inter-plane, between the second plane and the second inter-plane, and between the third plane and the second inter-plane.

For example, each of the first, second and third planes may correspond to a semiconductor chip, a package and a board.

In still other example embodiments of the present invention, a method of performing a numerical analysis on a power distribution network includes obtaining N planes respectively modeling N planes, and (N−1) inter-planes respectively modeling electrical interoperation between the neighboring planes, the N planes being vertically coupled; respectively performing numerical analyses on the N planes and the (N−1) inter-planes; and integrating the numerical analysis results based on electrical boundary conditions between the K-th plane of the N planes and the one or two inter-planes neighboring with the K-th plane.

Therefore, the power distribution network may be quickly analyzed with high accuracy. Additionally, each of the planes may be analyzed by using a conventional analysis program and additional resources may be not required.

### BRIEF DESCRIPTION OF THE DRAWINGS

FIG. 1 is a conceptual diagram illustrating a power distribution network of a hierarchical system having a package plane and a board plane.

FIG. 2 is a conceptual diagram for analyzing a power distribution network including a package plane and a board plane based on an inter-plane between the package plane and the board plane.

FIG. 3 is a conceptual diagram for analyzing a power distribution network including a semiconductor chip plane and a package plane based on an inter-plane between the semiconductor chip plane and the package plane.

FIG. 4 is a conceptual diagram for analyzing a power distribution network including a semiconductor chip plane, a package plane and a board plane based on an inter-plane between the semiconductor chip plane and the package plane and an inter-plane between the package plane and the board plane.

FIG. 5 is a flowchart illustrating a method of analyzing a power distribution network having two layers.

FIG. 6 is a flowchart illustrating a method of analyzing a power distribution network having three layers.

### DESCRIPTION OF THE EMBODIMENTS

Embodiments of the present invention now will be described more fully with reference to the accompanying drawings, in which embodiments of the invention are shown. The present invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout this application.

It will be understood that, although the terms first, second, etc. may be used herein to describe various elements, these elements should not be limited by these terms. These terms are used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention now will be described more fully hereinafter with reference to the accompanying figures, in which embodiments of the invention are shown. However, it should be understood that there is no intent to limit the invention to the particular forms disclosed, but on the contrary, the invention is to cover all modifications, equivalents, and alternatives falling within the spirit and scope of the invention as defined by the claims.

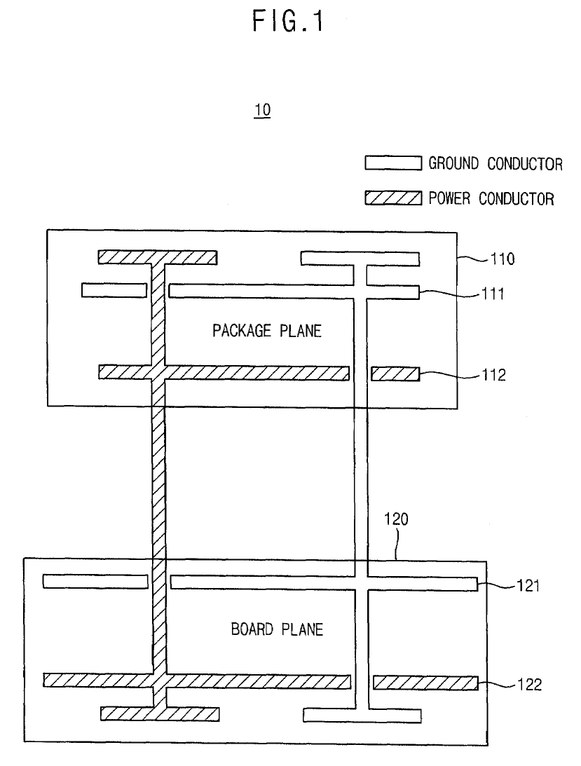

FIG. 1 is a conceptual diagram illustrating a power distribution network of a hierarchical system having a package plane and a board plane.

Referring to FIG. 1, a power distribution network 10 includes a package plane 110 and a board plane 120.

Each of the package plane 110 and the board plane 120 has separate ground conductors 111 and 121, and separate power conductors 112 and 122 in order to supply power. Generally, the ground conductors 111 and 121 are designed to be arranged below the power conductors 112 and 122, but the power conductors 112 and 122 may be arranged below the ground conductors 111 and 121. The ground conductors 111 and 121 and the power conductors 112 and 122 are arranged on each of the planes 110 and 120 in a repeating manner. The power conductors 112 and 122 of each of the planes 110 and 120 are vertically arranged to provide the power, and the ground conductors 111 and 121 thereof are vertically arranged.

Although it is nearly impossible to analyze impedance (i.e., voltage-current relationship) of the power distribution network 10 at once by using the commercial programs, it is possible to perform a numerical analysis on impedance of each of the ground conductors 111 and 121 and power conductors 112 and 122 within a feasible time and computing power. However, the impedance of the power distribution network 10 may not be obtained by integrating computation results between each of the planes 110 and 120, because the power conductors of the package plane 110 and the ground conductors of the board plane 120 are interoperated.

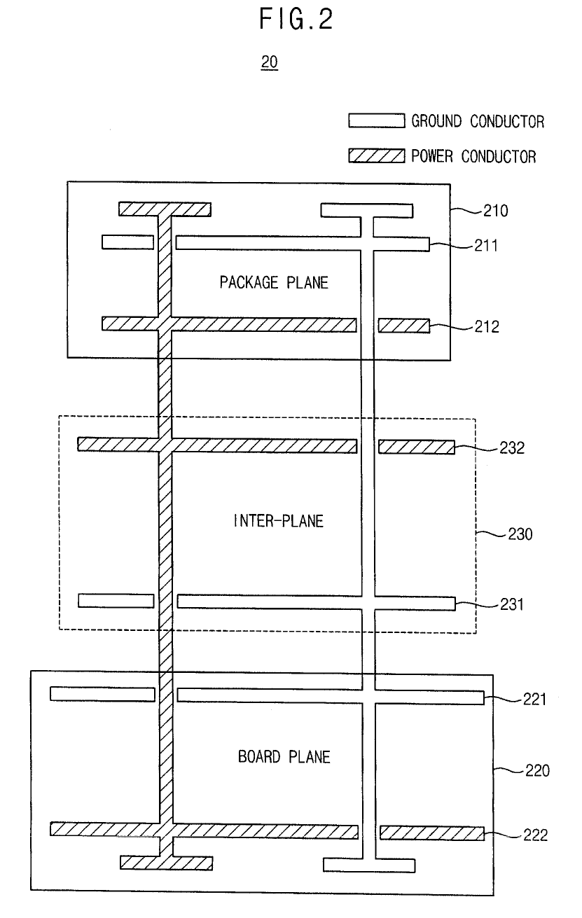

FIG. 2 is a conceptual diagram for analyzing a power distribution network including a package plane and a board plane based on an inter-plane between the package plane and the board plane.

Referring to FIG. 2, a power distribution network 20 of a hierarchical system includes a package plane 210 modeling a package, a board plane 220 modeling a board, and an inter-plane 230.

Similarly to FIG. 1, each of the package plane 210 and the board plane 220 has separate ground conductors, and separate power conductors, and the package and the board planes are vertically coupled.

In FIG. 2, the inter-plane 230 includes a power conductor 232 and a ground conductor 231, and the inter-plane 230 is inserted between the package plane 210 and the board plane 220. The inter-plane 230 is used for a numerical analysis and is a virtual plane mathematically modeling electrical interoperation between the package plane 210 and the board plane 220. In detail, the inter-plane 230 is a virtual plane mathematically modeling electrical interoperation between the power conductor 212 of the package plane 210 and the ground conductor 221 of the board plane 220.

After the package plane 210, the board plane 220 and the inter-plane 230 are respectively analyzed, and each of the above analyzed results is integrated based on a boundary condition (voltage and current) between the package plane 210 and the inter-plane 230, and a boundary condition (voltage and current) between the inter-plane 230 and the board plane 220. Therefore, the power network 20 may be quickly analyzed with high accuracy.

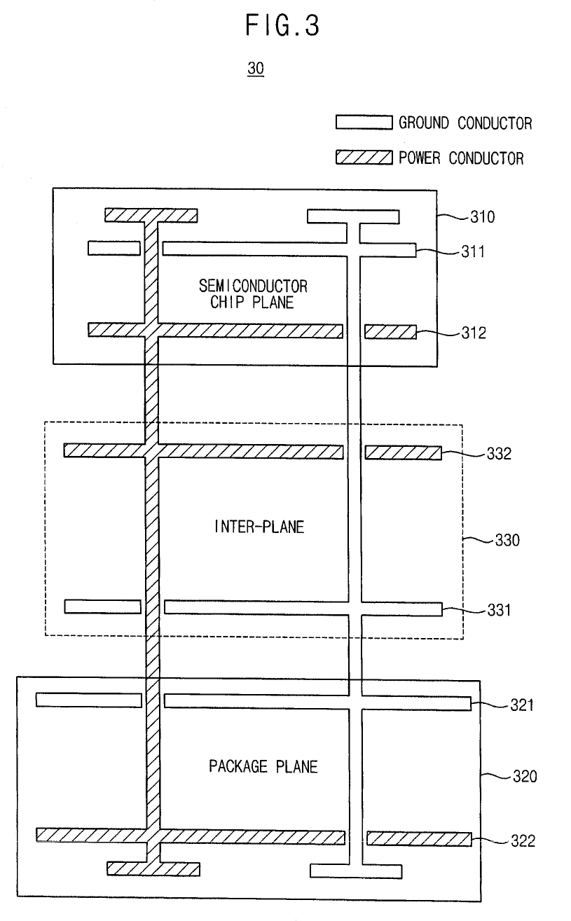

FIG. 3 is a conceptual diagram for analyzing a power distribution network including a semiconductor chip plane and a package plane based on an inter-plane between the semiconductor chip plane and the package plane.

Referring to FIG. 3, a power distribution network 30 of a hierarchical system includes a semiconductor chip plane 310 modeling a semiconductor chip, a package plane 320 modeling a package and an inter-plane 330.

Similarly to FIG. 2, each of the semiconductor chip plane 310 and the package plane 320 has separate ground conductors 311 and 321, and separate power conductors 312 and 322, and the inter-plane 330 is inserted between the semiconductor chip plane 310 and the package plane 320.

For example, the semiconductor chip plane 310 and the package plane 320 may be coupled through various methods such as a bonding wire. The inter-plane 330 is used for a numerical analysis and is a virtual plane mathematically modeling electrical interoperation between the semiconductor chip plane 310 and the package plane 320. In detail, the inter-plane 330 is a virtual plane mathematically modeling electrical interoperation among a power conductor 312 of the semiconductor chip plane 310, a ground conductor 321 of the package plane 320, and bonding wires (not illustrated) between the power conductor 312 and the ground conductor 321.

After the semiconductor chip plane 310, the package plane 320 and the inter-plane 330 are respectively analyzed, and each of the above analyzed results is integrated based on a boundary condition (voltage and current) between the semiconductor chip plane 310 and the bond plane 330 and a boundary condition (voltage and current) between the bond plane 330 and the package plane 320. Therefore, the power network 30 may be quickly analyzed with high accuracy.

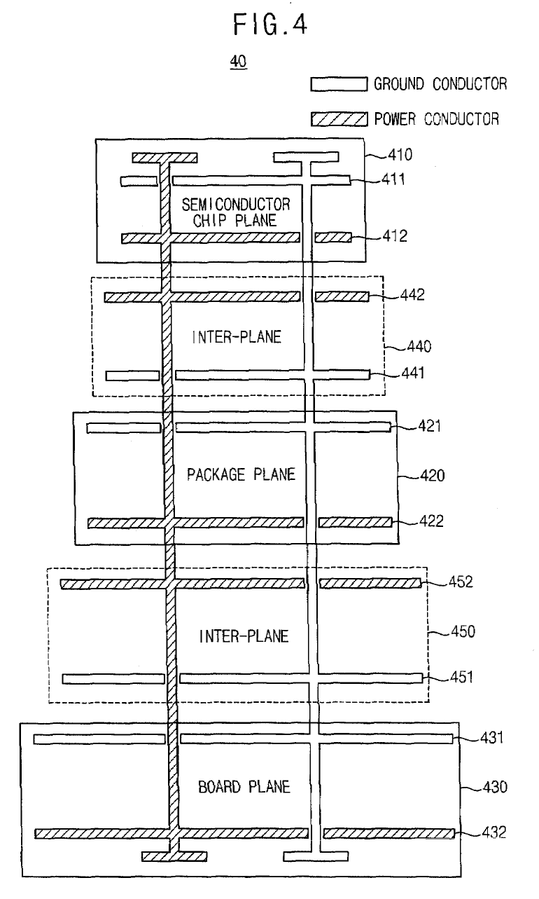

FIG. 4 is a conceptual diagram for analyzing a power distribution network including a semiconductor chip plane, a package plane and a board plane based on an inter-plane between the semiconductor chip plane and the package plane and an inter-plane between the package plane and the board plane.

Referring to FIG. 4, a power distribution network 40 of a hierarchical system includes the semiconductor chip plane 410 modeling a semiconductor chip, a package plane 420 modeling a package, a board plane 430 modeling a board, a first inter-plane 440 and a second inter-plane 450.

Similarly to FIGS. 2 and 3, each of the semiconductor chip plane 410, the package plane 420 and the board plane 430 has separate ground conductors 411, 421 and 431, and separate power conductors 412, 422 and 432.

The first inter-plane 440 is inserted between the semiconductor chip plane 410 and the package plane 420, and the second inter-plane 450 is inserted between the package plane 420 and the board plane 430.

After the semiconductor chip plane 410, the package plane 420, the board plane 430, the first inter-plane 440, and the second inter-plane 450 are respectively analyzed, and each of the above analyzed results is integrated according to a boundary condition (voltage and current) between each of the planes. Therefore, the power network 40 may be quickly analyzed with high accuracy.

In one example embodiment, after the semiconductor chip plane 410 and the package plane 420 are respectively analyzed based on the boundary condition of the first inter-plane 440 and the analyzed results are applied to the boundary condition between the package plane 420 and the board plane 430, the power network 40 may be analyzed.

In another example embodiment, after the package plane 420 and the board plane 430 are respectively analyzed based on the boundary condition of the second inter-plane 450 and the analyzed results are applied to the boundary condition between the semiconductor chip plane 410 and the package plane 420, the power network 40 may be analyzed.

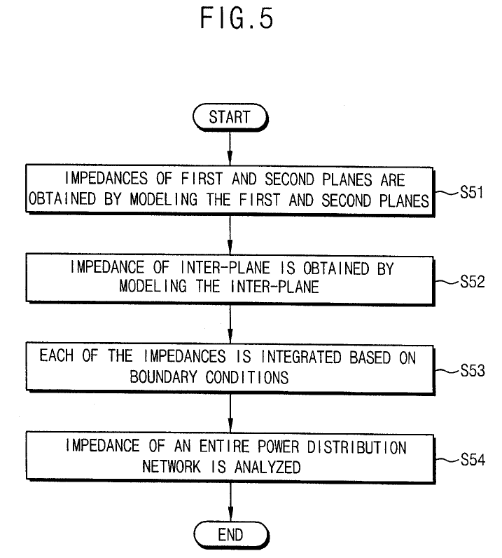

FIG. 5 is a flowchart illustrating a method of analyzing a power network having two planes.

FIG. 5 assumes that a power distribution network includes a first plane modeling a first layer, a second plane modeling a second layer, and an inter-plane between the first plane and the second plane.

The first and second planes are obtained by modeling the first and second planes (Step S51), and the inter-plane is obtained by modeling electrical interoperation between the first and second planes (Step S52).

Each of the impedances of the first plane, the second plane and the inter-plane is integrated based on a boundary condition between the first plane and the inter-plane and a boundary condition between the inter-plane and the second plane (Step S53).

Therefore, the impedance of the entire power distribution network may be analyzed (Step S54).

In one example embodiment, the first plane may correspond to a package plane and the second plane may correspond to a board plane. In another embodiment, the first plane may correspond to a semiconductor chip plane and the second plane may correspond to a package plane.

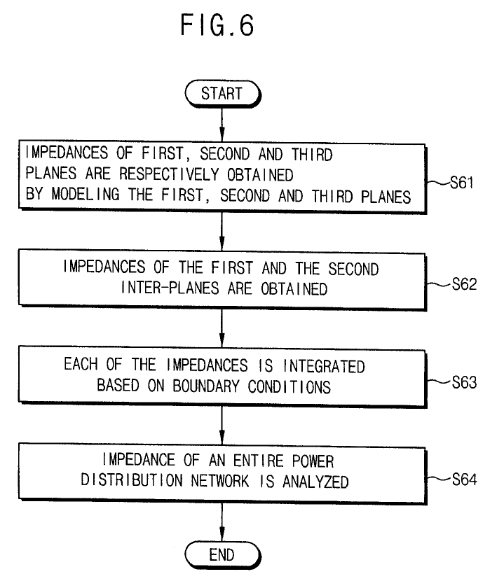

FIG. 6 is a flowchart illustrating a method of analyzing a power distribution network having three layers.

Referring to FIG. 6, a power distribution network includes a first plane, a second plane, a third plane, a first inter-plane and a second inter-plane.

The first, second and third planes are respectively obtained by modeling the first, second and third layers (Step S61).

The first inter-plane is obtained by modeling a first electrical interoperation between the first and second planes and the second inter-plane is obtained by modeling a second electrical interoperation between the second and third planes (Step S62).

Each of the impedances of the first plane, the second plane, the third plane, the first inter-plane and the second inter-plane is integrated based on a boundary condition between the first plane and the first inter-plane, a boundary condition between the first inter-plane and the second plane, the second plane and the second inter-plane, and the second inter-plane and the third plane (Step S63).

Therefore, the impedance of the entire power distribution network is analyzed (Step S64).

The first, second and third planes may respectively correspond to a semiconductor chip plane, a package plane and a board plane. In the above, the power distribution network having three layers is explained, but any power distribution network having a hierarchical architecture may be applied.

As described above, the power distribution network according to the above example embodiments of the present invention may be quickly analyzed with high accuracy.

Additionally, each of the planes may be analyzed by using a conventional analysis program and additional resources may be not required.

While the example embodiments of the present invention and their advantages have been described in detail, it should be understood that various changes, substitutions and alterations may be made herein without departing from the scope of the invention.

What is claimed is:

1. A method of performing a numerical analysis on a power distribution network having first and second planes, the first and second planes being vertically coupled, the method comprising:
obtaining a model of the first plane, a model of the second plane, and a model of an inter-plane, the model of the inter-plane defining electrical interoperation between the first and second planes;
respectively performing numerical analyses on the models of the first plane, the second plane and the inter-plane; and
integrating the numerical analysis results based on an electrical boundary condition between the models of the first plane and the inter-plane, and an electrical boundary condition between the models of the second plane and the inter-plane.

2. The method of claim 1, wherein each of the first and second planes respectively correspond to a semiconductor chip and a package.

3. The method of claim 1, wherein the first and second planes respectively correspond to a package and a board.

4. A method of performing a numerical analysis on a power distribution network having first, second and third planes, the first, second and third planes being vertically coupled, the method comprising:
obtaining a model of the first plane, a model of the second plane, a model of the third plane, a model of a first inter-plane, and a model of a second inter-plane, the model of the first inter-plane defining electrical interoperation between the first and second planes and the model of the second inter-plane defining electrical interoperation between the second and third planes;
respectively performing numerical analyses on the models of the first, second and third planes, and the models of the first and second inter-planes; and
integrating the numerical analysis results based on electrical boundary conditions between the first plane and the first inter-plane, between the second plane and the first inter-plane, between the second plane and the second inter-plane, and between the third plane and the second inter-plane.

5. The method of claim 4, wherein each of the first, second and third planes respectively correspond to a semiconductor chip, a package and a board.

6. A method of performing a numerical analysis on a power distribution network, comprising:
obtaining N planes respectively modeling N planes and (N−1) inter-planes respectively modeling electrical interoperation between the neighboring planes, the N layers being vertically coupled;
respectively performing numerical analyses on the N planes and the (N−1) inter-planes; and
integrating the numerical analysis results based on electrical boundary conditions between the K-th plane of the N planes and the one or two inter-planes neighboring with the K-th plane.
